(19) United States
(12) Patent Application Publication
(10) Pub. No.: US 2006/0125477 A1
(43) Pub. Date: Jun. 15, 2006

(54) Sample inspection apparatus for combining nmr with esr or icr-mass spectroscopy

(76) Inventors: Neil Killoran, Oxon (GB); Francis John Trundle, East Sussex (GB); Francis John Brown, Oxfordshire (GB)

Correspondence Address: STAAS & HALSEY LLP, SUITE 700, 1201 NEW YORK AVENUE, N.W., WASHINGTON, DC, 20005, US

(21) Appl. No.: 10/532,345

(22) PCT Filed: Nov. 18, 2003
(86) PCT No.: PCT/GB03/04987

§ 371 Date: Jan. 3, 2006

(30) Foreign Application Priority Data
Nov. 19, 2002 (GB) 0226996.7

(51) Int. Cl. G01V 3/00

(52) U.S. Cl. 324/321; 324/307; 324/306; 324/303

(57) ABSTRACT

Sample inspection apparatus comprises a pair of magnet assemblies (28A, 28B) located in a common cryostat (10) and surrounding respective bores (24, 26) at room temperature so as to define corresponding working regions (30, 32) in the bore. A first, NMR probe (6) can be inserted in one of the bores to bring a sample into the corresponding working region, the magnetic field in that working region having a homogeneity or profile suitable for performing a NMR experiment. A second probe (5) can be inserted in the other of the bores to bring a sample into the other working region, the magnetic field in that working region having a homogeneity or profile suitable for performing a different experiment on the sample.

The invention relates to sample inspection apparatus and in particular to nuclear magnetic resonance (NMR) inspection apparatus.

NMR has been developed over many years to enable chemical information about samples such as their molecular structure to be obtained. This is carried out using NMR spectroscopy. The NMR measurement process involves the generation of a high strength, uniform magnetic field within a working volume. The sample is located in the working volume and then subjected to RF irradiation causing the spins of certain nuclei to precess. On removing the RF irradiation, the spins return to their rest state and their precession frequency can be monitored thus giving an indication of structural information and the like.

In many analytical situations, other information about samples is often needed as well thus requiring additional experimental equipment to be provided. An example is Fourier Transform Ion Cyclotron Resonance Mass Spectroscopy (FTICR). The FTICR measurement process involves the generation of a high strength, uniform magnetic field within a working volume. Charged ions from the sample under investigation are injected into a vacuum chamber (ICR cell) within the working volume and there experience cyclotron motion in the magnetic field. The cyclotron motion can be excited in a controlled way using RF radiation. The nature of the cyclotron motion of specific ions is detected as an electrical signal in electrodes within the ICR cell. This electrical signal is processed to provide data on the mass of the ions under investigation.

Typically, chemical samples of very small volume are analysed, for example in the order of femtomoles.

A number of problems arise in these circumstances. Firstly, each experiment requires a high strength magnet located within a cryostat and these are large, bulky and very expensive. In addition, problems arise when attempting to analyse the same sample in more than one way since there are risks of contamination and an inability to carry out the tests simultaneously.

In accordance with a first aspect of the present invention, we provide sample inspection apparatus comprising a pair of magnet assemblies located in a common cryostat and surrounding respective bores so as to define corresponding working regions in the bores; a first sample positioning mechanism which can be inserted in one of the bores to bring a sample into the corresponding working region, the magnetic field in that working region having a homogeneity or profile suitable for performing a NMR experiment; and a second sample positioning mechanism which can be inserted in the other of the bores to bring a sample into the other working region, the magnetic field in that working region having a homogeneity or profile suitable for performing a different experiment on the sample.

We have realised that there are significant synergies between NMR apparatus on the one hand and certain other experimental apparatus, particularly FTICR, on the other hand. Thus, both require a high strength, substantially uniform magnetic field and so both typically need a cryostat in order to cool the windings of a magnet to low temperature to achieve superconductivity. This enables the high strength magnetic field to be generated cost effectively. Each type of apparatus uses a sample positioning mechanism such as a probe within which the sample is located in use, the probe being inserted into a room temperature bore of the cryostat. We therefore recognised that it is possible to house both magnet assemblies in a common cryostat.

For relatively low field magnet assemblies, these can be placed in proximity with one another without generally interfering but for high field magnets which are more commonly used for NMR and FTICR, it is necessary to consider carefully the way in which the magnet assemblies interact. These include considering the reaction forces between the magnet assemblies, the influence of the stray or external fringe field from one magnet assembly on the magnitude of the central field of the other, and the influence of the gradients within the stray or external fringe field from one magnet assembly on the field uniformity (homogeneity) of the other.

All these considerations can be addressed by suitably shielding the magnet assemblies. Two methods are available, passive by means of ferromagnetic material or active by means of reverse energised coil sets positioned within the individual magnet coil assemblies so as to reduce the stray or external fringe field from the magnet. These coils can be considered to shape the fringe fields that exist between two (or more) magnets in close proximity so as to reduce the magnetic influence one on the other. Active shielding is preferred because it reduces the weight of the assemblies and can shield a variety of fields generated by the magnet assemblies.

We have found, in particular, that in order to reduce the influence of the two magnet assemblies on each other, in most cases active, end shielding coils should be provided.

We have also realised that an important factor determining a condition when the influence of the two magnet assemblies on each other is acceptable is that the external fringe field generated by each magnet assembly is ideally no greater than 0.0005 T at the centre of the working region defined by the other magnet assembly with the reversed energised active shielding coils in place.

The magnet assemblies could be arranged end to end to define a common bore but this will have a significant length which in some cases may be undesirable. In the preferred arrangement, therefore, the magnet assemblies are arranged with their bores substantially parallel and side by side. It has been found that due to the anisotropic nature of the fringe or external fields generated by the magnet assemblies, they can be placed relatively close together when side by side as compared to the situation in which they are placed end to end.

In general, the two magnet assemblies will be electrically separate and separately powered but in some cases could be electrically connected in series so as effectively to define a single magnet but with two working regions.

In some cases, the two sample positioning mechanisms, such as probes, can be arranged simultaneously in the bore(s) so that both experiments can be carried out simultaneously. As will be explained in more detail below, this allows the same sample to be analysed in two different ways substantially simultaneously and avoids problems of time delay between carrying out the two experiments, contamination etc.

Although this aspect is primarily concerned with the use of two working regions, it is possible to extend the concept to more than two regions.

In accordance with a second aspect of the present invention, we provide sample inspection apparatus comprising a magnet assembly located in a cryostat and surrounding a bore so as to define a working region in the bore; a first sample positioning mechanism which can be inserted in the bore to bring a sample into the working region, the magnet assembly being controllable to generate a magnetic field in the working region having a homogeneity or profile suitable for performing a NMR experiment; and a second sample positioning mechanism which can be inserted in the bore to bring a sample into the working region, the magnet assembly being controllable to generate a magnetic field in the working region having a homogeneity or profile suitable for performing a different experiment on the sample.

In this case a single magnet assembly is provided which generates a single working region of substantially uniform magnetic field in the bore. The sample positioning mechanisms, which are adapted for different experiments, could be inserted into the same end of the bore in turn or more preferably can be inserted from opposite ends of the bore with one mechanism being arranged to bring its sample into the working region followed by the other.

Although the “different experiment” is described herein as FTICR, other experiments are also possible, such as EPR (electron paramagnetic resonance) or ESR (electron spin resonance).

Advantages of the invention include a reduced cost since only a single cryostat, and in some cases a single magnet, is required to obtain the same experimental data previously requiring two separate structures. Also the proximity or even commonality of the two working regions provides for increased sample throughput, reduced contamination, and improved confidence of data, for example when needing to process FTICR data and NMR data simultaneously particularly with respect to mass confirmation in conjunction with NMR. An example of this is the need to use NMR to obtain the 3D structure of a protein and FTICR to obtain peptide sequencing data.

Some examples of apparatus according to the present invention will now be described with reference to the accompanying drawings, in which:—

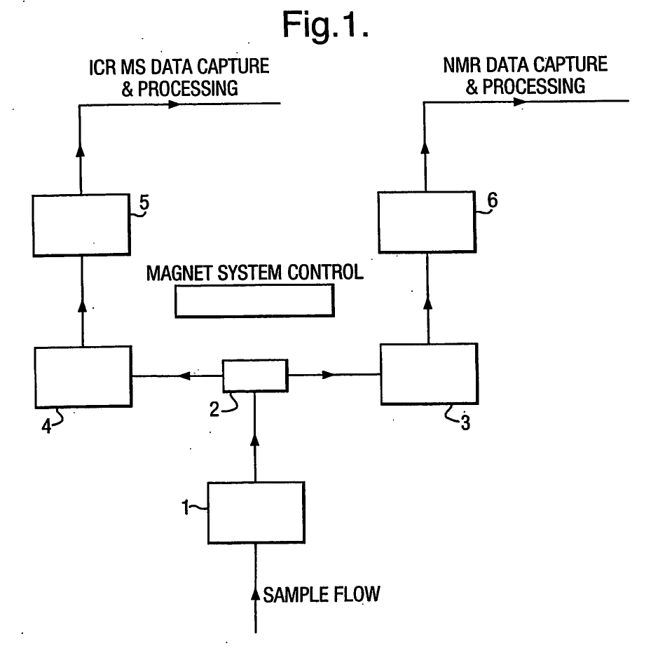

FIG. 1 is a block diagram illustrating the primary components of an analytical instrument applicable to any of the examples shown in the following drawings;

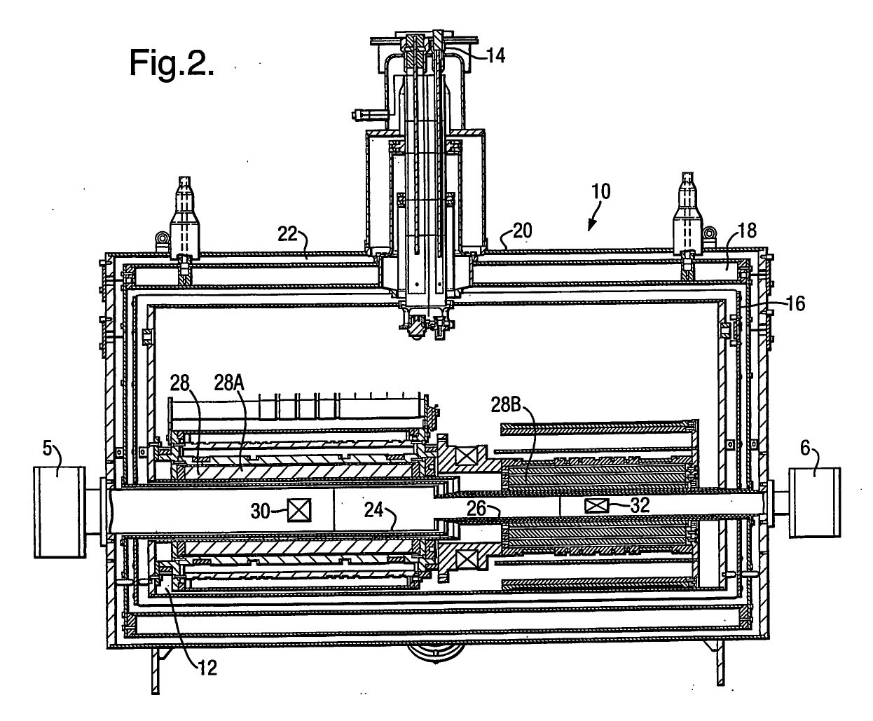

FIG. 2 is a longitudinal section through a first example of the sample inspection apparatus;

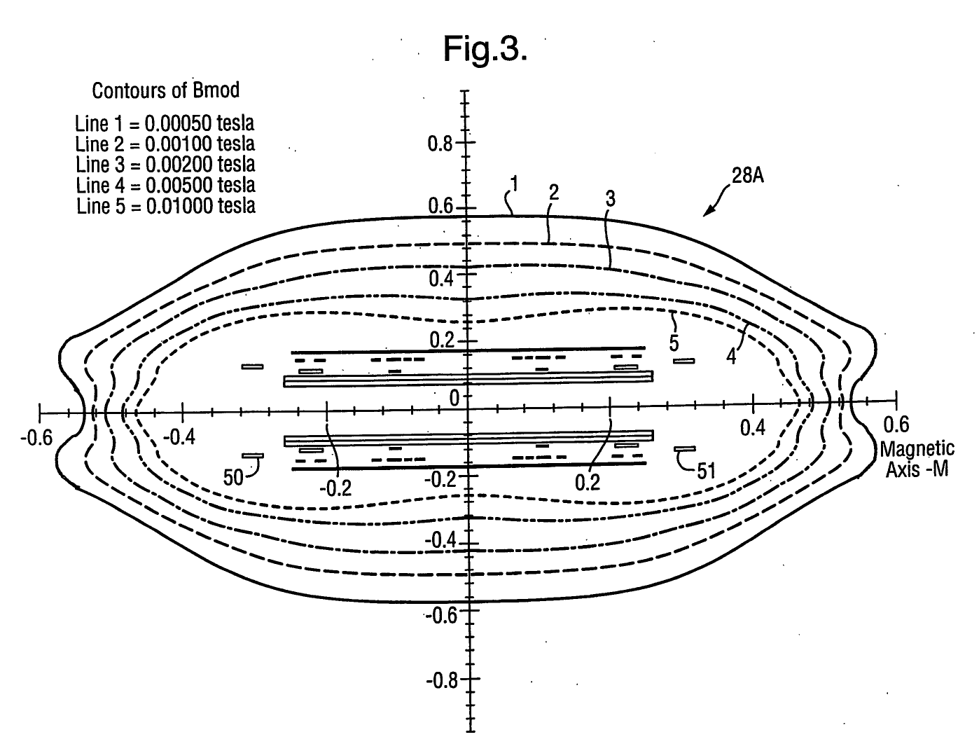

FIG. 3 is a contour map of the fringe field generated by the FTICR magnet assembly alone in the FIG. 2 example;

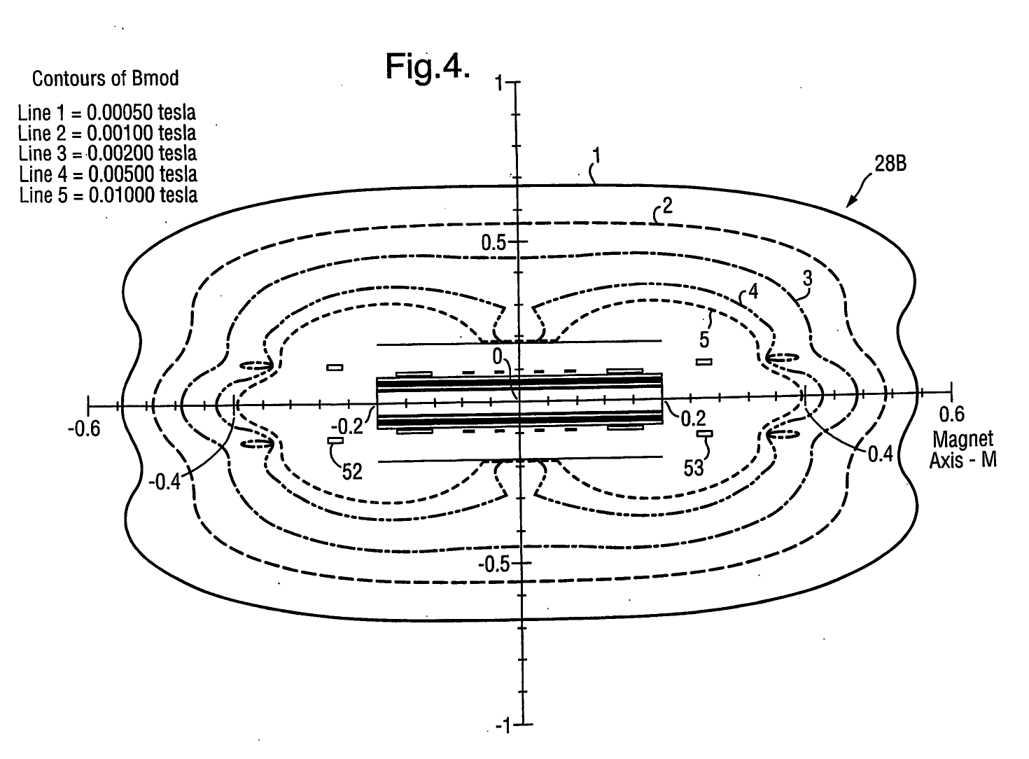

FIG. 4 is a contour map of the fringe field generated by the NMR magnet assembly alone in the FIG. 2 example;

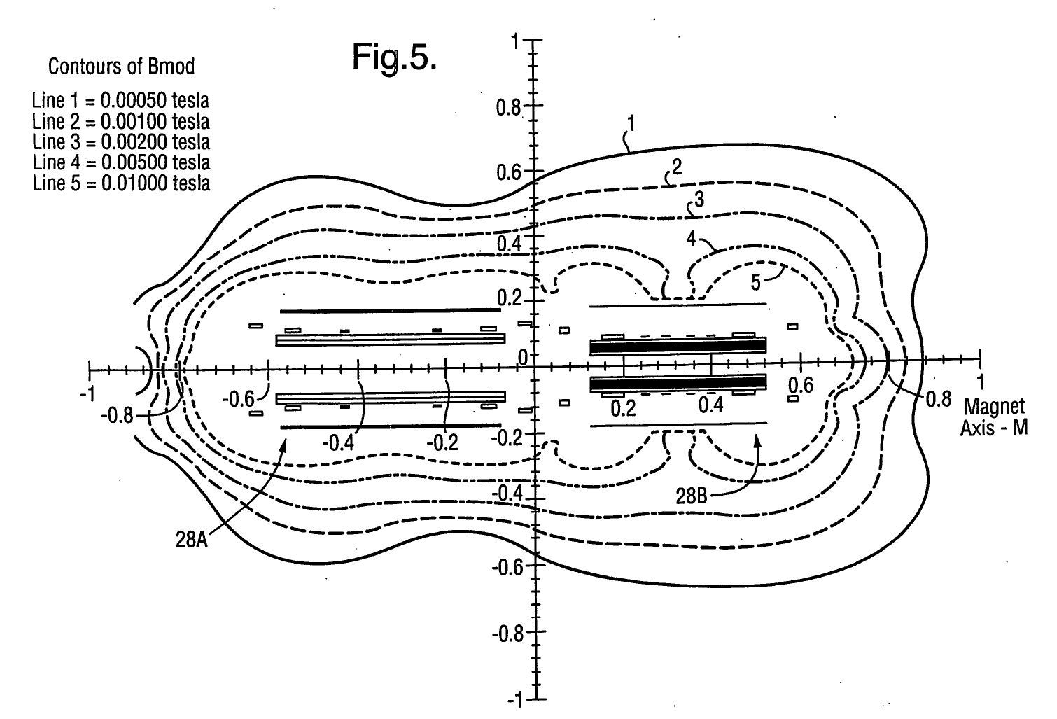

FIG. 5 is a contour map of the fringe field generated by the combined magnet assemblies in FIG. 2;

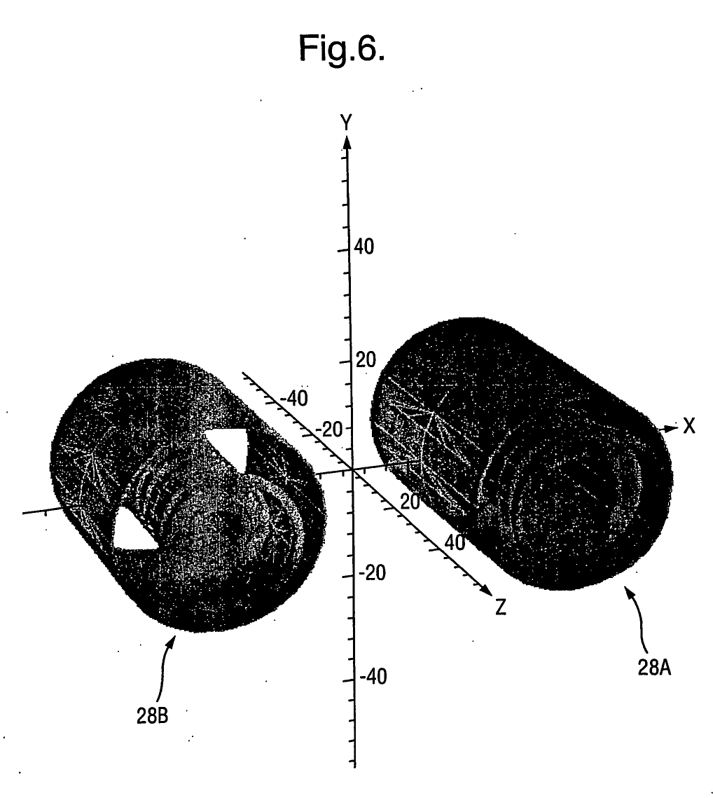

FIG. 6 illustrates a second example with the magnet assemblies arranged side by side;

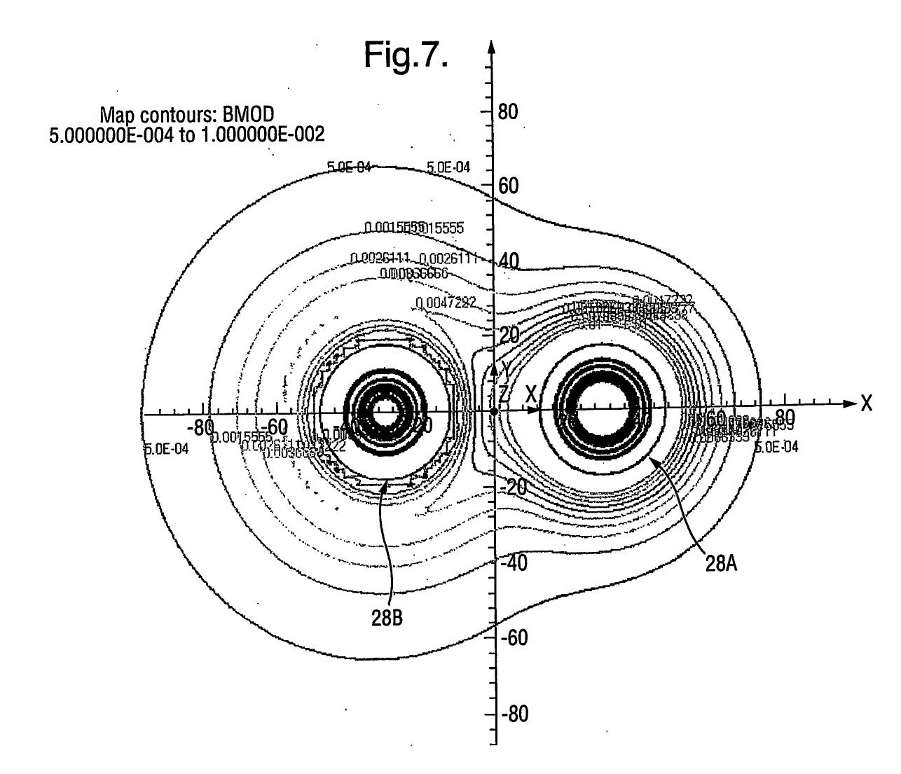

FIG. 7 is a contour map of the fringe field of the FIG. 6 example from an end perspective;

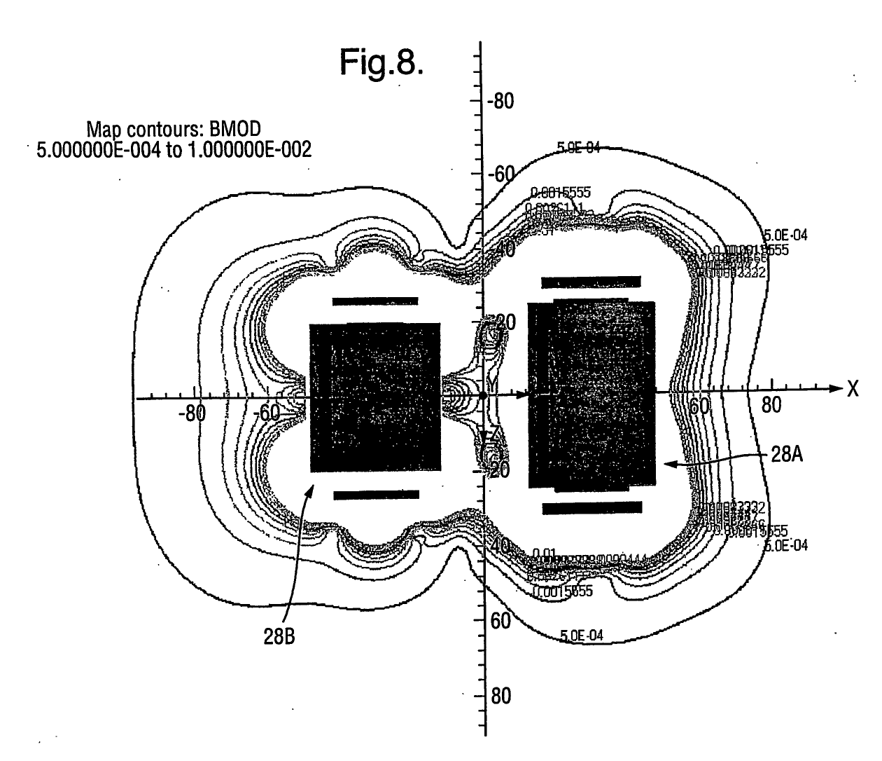

FIG. 8 is a contour map of the fringe field of the FIG. 6 example from a plan perspective; and,

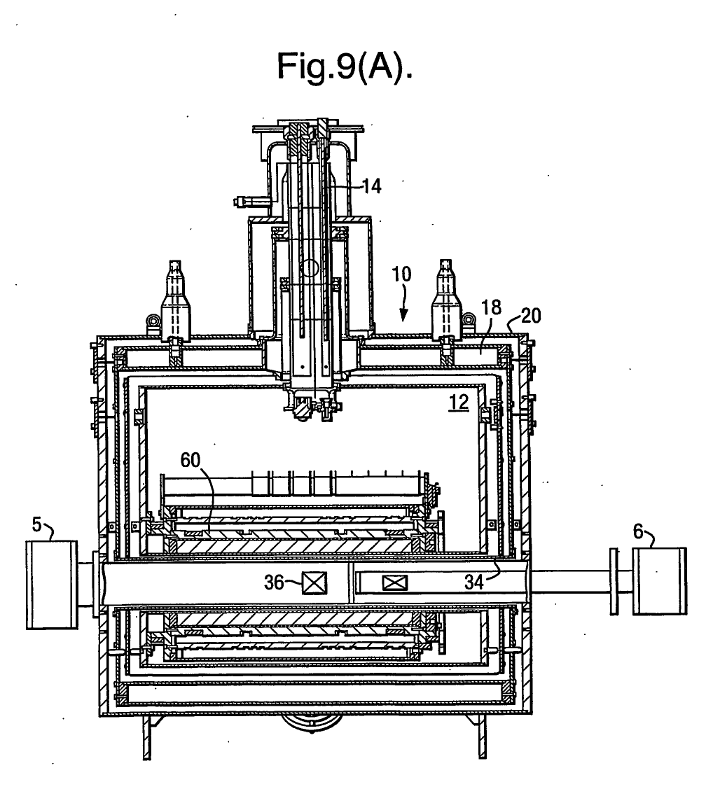

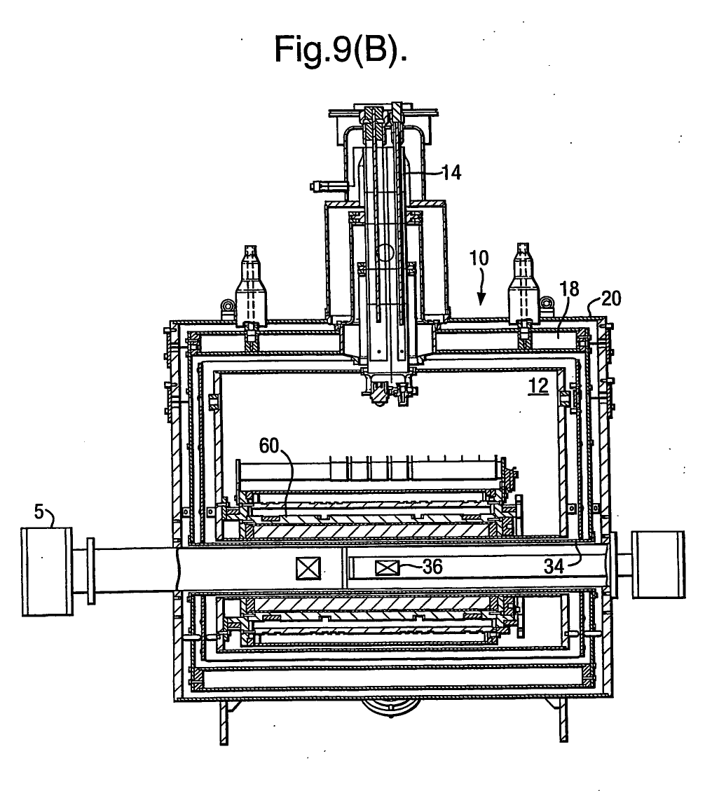

FIGS. 9A and 9B are longitudinal sections through a third example in two different conditions.

The apparatus shown in FIG. 1 comprises a conventional liquid chromatograph 1 to which a sample to be analysed is supplied. The chromatograph l separates out the component to be analysed which, as explained above, will be of very small volume, and this is fed to a flow splitter 2. The sample is then split with a proportion passing to NMR sample injection equipment 3 and the remaining portion to ICR mass spectrometer sample injection equipment 4. The sample from the equipment 4 is then supplied to an ICR mass spectrometer ultra high vacuum (UHV) cell 5 while the sample from the equipment 3 is passed to an NMR RF probe 6.

In operation, the cell 5 and the probe 6 will generate output signals which are captured and then processed, typically by a common microcomputer or other processor so that the results can be compared accurately and easily on the basis that the tests were carried out, often simultaneously, on the same sample.

Typically, the probe 6 will carry a single sample. However, in some cases the probe could carry a multiple receiver array comprising a plurality of receiving circuits, each comprising receiving means and end circuit having a different spatial sensitivity to each sample. This is described in more detail in GB0307116.4.

FIG. 2 illustrates a first example of the sample inspection apparatus which can be used with the FIG. 1 arrangement. The apparatus comprises a cryostat 10 of conventional form having a central liquid helium vessel 12 accessed via an access and service neck 14. This is surrounded by a gas cooled radiation shield 16 which in turn is surrounded by a liquid nitrogen containing vessel 18. Finally, the outer wall 20 of the cryostat is separated from the liquid nitrogen vessel 18 by an evacuated chamber 22.

The cryostat surrounds a room temperature bore having a large diameter section 24 continuing into a narrower diameter section 26. An actively shielded magnet system 28 is located in the liquid helium vessel 12 and surrounds the bore 24,26. The magnet system is split into two assemblies 28A,28B, one surrounding each part of the bore 24,26 and each generating a substantially uniform field within a respective working region 30,32. The two assemblies are typically electrically connected in series although they could be separately powered. Typical examples of the uniformity achieved in each region are ±100 ppm within a 50 mm diameter and 80 mm length cylinder for the region 30 and ±10⁻⁸ within a 5 mm diameter and 20 mm length cylinder for the region 32.

The magnet assemblies may also be housed within a liquid helium reservoir which is cooled by a cryogenic refrigerator (not shown), typically a Gifford-McMahon or pulse tube refrigerator, such that the coldest stage of the refrigerator applies cooling power, at the boiling point temperature of the liquid helium in the reservoir, regulated by the appropriate control mechanism to balance the ambient heat load on to the liquid helium reservoir through re-condensation of evaporating helium. This enables zero loss of liquid helium to be achieved. In another embodiment the actual volume of liquid helium reservoir can be minimised such that the helium reservoir can then be coupled externally to a buffer gas reservoir which would be sufficient to hold any excess expanded helium gas at a few atmospheres of pressure if the entire system were to warm up to room temperature. This allows the system to be entirely closed and self contained, the so called MCV approach described in more detail in U.S. Pat. No. 5,979,176. Alternatively, the magnet assembly could be cooled by direct thermal conduction from the coldest stage of a cryogenic refrigerator referred to above, to a temperature low enough for the superconducting magnet assembly to achieve its superconducting operating condition. No liquid cryogens would be required within the magnet and cryostat structure in this case. To further enable the elimination of the use of liquid cryogens in this type of system, warmer stages of the cryogenic refrigerator could be coupled to the thermal shields in the cryostat structure to cool these shields to intercept the ambient heat load, instead of using liquid cryogens typically liquid nitrogen.

In addition to the main, actively shielded magnet system 28, additional shims etc (not shown) will be provided either in the cryostat or in the room temperature bore 24,26 as required. This will be well understood by a person of ordinary skill in the art and so will not be described further in detail.

Removably inserted into the bore 26 is the NMR RF probe 6 which also contains shim coils and sample injection equipment. Into the bore 24 is inserted the UHV ICR cell and sample injection equipment 5. The cell 5 and probe 6 will be connected to the other equipment as shown in FIG. 1.

Either the NMR RF probe 6 or the UHV FTICR cell 5 or both may contain signal detecting coils (NMR probe) or detection electrodes (FTICR cell) and detection electronics (e.g. pre-amplifier stage) which are cooled to reduce Johnson noise in these elements of the system, thereby improving the signal to noise ratio of the overall measurements. Conventionally these elements are operated near room temperature. Cryogenic temperatures of typically 20K may be achieved using direct cooling with cold gas, typically helium, through heat exchange elements coupled to the detecting coils, electrodes or electronics as described in WO03/023433.

In operation, magnetic fields of the desired strength and uniformity can be produced simultaneously in the working volumes 30,32 so that the FTICR and NMR experiments can be carried out on the samples simultaneously or sequentially.

As explained above, it is important to consider the interaction between the two magnet assemblies 28A,28B. This interaction is reduced by the fact that the individual assemblies 28A,28B are actively shielded and include actively shielding end coils 50,51 for the magnet assembly 28A (FIG. 3), and end shielding coils 52,53 for the NMR magnet assembly 28B (FIG. 4). In this example, the magnet assembly 28B is a NMR magnet producing a 9.4 T field and having a 54 mm bore and modified to include the active end coils 52,53 while the magnet assembly 28A is a 7 T 95 mm ambient temperature bore magnet.

As can be seen in FIG. 3, the fringe field contour corresponding to a value of 0.00050 T extends to about 0.6 metres radially and about a similar distance axially. While for the NMR magnet assembly 28B, (FIG. 4) the same contour extends to about 0.7 metres radially and 0.6 metres axially. This should be contrasted with a conventional actively shielded 400/54 AS magnet in which the same contour extends to about 1 metre radially and 1.5 metres axially. The use of the end active shielding coils 52,53 has significantly reduced the fringe field.

If the two magnets are to be combined within a single cryostat as in FIG. 2, then we have determined that the magnetic field at the centre of one magnet should experience ideally no more than 0.00050 T of the fringe field of the other magnet. As will be understood from the above discussion, this could be achieved by positioning the two magnet assemblies 28A,28B such that their centres (the centres of the working regions) are about 615 mm apart. If they are arranged with that separation (the minimum to avoid physical coil clashes and to provide a small axial net force) then the following parameters are realised.

Influences of 7T ICR and alternative 400/54AS magnets on each
other with 0.65 meter axial separation

| | | |
|---|---|---|
| Parameter | 7T ICR on 400/54AS | 400/54AS on 7T ICR |
| Field shift | 0.00025 T | 0.00002 T |
| Homogeneity | (Z = 1) Z1 = 0.9 PPM | (Z = 4) Z1 = 13.9, |
| | | Z2 = 3.7, Z3 = 0.6, |
| | | Z4 = 0.1 PPM |
| Net force | 1055N | 1055 N |
| magnitude | | |

As can be seen from the table the field shift at the 400/54AS is the same as in the previous example but that at the 7 T ICR is much lower. The only significant homogeneity effect on the 400/54AS is a small Z1 influence whilst the homogeneity of the 7 T ICR is now much smaller and well within the normal shim adjustment range (<1 amp in z1/2&3 shims).

FIG. 5 shows a representation of the arrangement of the two magnets with the nominal overall dimensions.

As will be seen from the overall dimensions the diameters of the two magnets 28A,28B are very similar. In a horizontal configuration this would therefore lead to a system of the same diameter as the ICR system alone but with a length about twice that of that system. Typically the overall dimensions may be 900 mm diameter×1700 mm long. The system would typically require two service necks in order to accommodate the dual magnet services required and to support and distribute the magnet weight.

In a vertical configuration the magnet assemblies 28A,28B would require a standard diameter NMR cryostat with extra height, for example a bore length of 1800 mm. The requirement for dual magnet services would require the use of three necks.

FIG. 6 illustrates an alternative arrangement in which the two magnet assemblies 28A,28B have been arranged with their bores parallel and side by side.

The field contours of this system of FIG. 6 are shown in FIGS. 7 and 8 with the outermost contour defining where the fringe field is 0.00050 T.

In all FIGS. 6 to 8, length dimensions are in centimetres.

In this example, the most significant influence from one magnet to the other is the field gradient across the sample volume in the X direction. Some small Z direction gradients are produced and the net force between the magnets is very small. The effects are summarised in the following table.

Influences of 7T ICR and alternative 400/54AS magnets on each
other with 0.6 meter radial separation

| | | |
|---|---|---|
| Parameter | 7T ICR on 400/54AS | 400/54AS on 7T ICR |
| Field shift | 0.00041 tesla | 0.00076 tesla |
| Transverse | 0.23 PPM on 1 cm æ | ±16 PPM on 5 cm æ |
| homogeneity | | |
| Axial | 0.056 PPM at z = 1 cm | 2.85 PPM at z = 4 cm |
| homogeneity | | |
| Net force | 2.5 N | 2.5N |

As with the common axes case (FIG. 2) the most significant influence is on the homogeneity of the ICR magnet 28A. The X direction gradient produced by the stray field from the 400/54AS magnet 28B is not quite linear. The non-linearity is however only of the order of ±1.5 PPM which is well within the specification for this type of magnet (±10 PPM) and the strength of the first order transverse shim coils (<2.0 Amp operating current).

The cryogenic arrangement for the system shown in FIGS. 6 to 8 in either horizontal or vertical mode will be a modified form of a conventional arrangement (not shown).

In the horizontal mode a cryostat of about 1300 mm diameter and 900 mm length would be required. In the vertical mode the cryostat would again have a diameter of about 1300 mm with a bore length of perhaps 1100 mm.

It will be noted that with the parallel arrangement (FIGS. 6 to 8) a minimum separation of 600 mm is achievable allowing for correction of the field gradients produced across the sample volumes in the plain containing the magnet axes. Only small axial field gradients are introduced and the net force between the magnet assemblies is very low due to their relative orientation.

FIGS. 9A and 9B illustrate a third example. In this example, the basic construction of the cryostat is the same as in the FIG. 2 example and will not be described further. The difference between the two examples is that a single magnet assembly 60 is used having a room temperature bore 34 having a substantially constant cross-section is provided and a single working region 36 having a substantially uniform magnetic field is generated by the magnet assembly 60. The ICR cell probe 5 and the NMR probe 6 are simultaneously located in the bore 34 but only one can be brought into alignment with the working region 36 at any one time. In FIG. 9A, the FTICR cell probe 5 has been brought to bring its sample region into the working region 36 while in FIG. 9B the NMR probe 6 has been pushed into the bore sufficiently to bring its sample region into alignment with the working region.

1. A sample inspection apparatus comprising:
a pair of magnet assemblies located in a common cryostat and surrounding respective bores so as to define corresponding working regions in the bores;
a first sample positioning mechanism insertable in one of the bores to bring a sample into the corresponding working region, the magnetic field in that working region having a homogeneity or irofile suitable for performing a NMR experiment; and
a second sample positioning mechanism insertable in the other of the bores to bring a sample into the other working region, the magnetic field in that working region having a homogeneity or profile suitable for performing a different experiment on the sample.

2. Apparatus according to claim 1, wherein the external field generated by each magnet assembly is no greater than 0.0005 T at the centre of the working region defined by the other magnet assembly.

3. Apparatus according to claim 1 or claim 2, wherein each magnet assembly is actively shielded.

4. Apparatus according to claim 3, wherein each magnet assembly has end shielding coils.

5. Apparatus according to claim 1 or 2, wherein the magnet assemblies are arranged with their bores coaxial to define a common bore.

6. Apparatus according to claim 5, wherein the sample positioning mechanisms are insertable into opposite ends of i u common bore.

7. Apparatus according to claim 5, wherein the magnet assemblies comprise a single magnet.

8. Apparatus according to claim 1 or 2, wherein the magnet assemblies are arranged with their bores substantially parallel and side by side.

9. Apparatus according to claim 1 or 2, wherein the magnet assemblies are controllable to generate the required magnetic fields in each working region simultaneously.

10. Apparatus according to claim 1 or 2, wherein the bores are at room temperature.

11. A sample inspection apparatus comprising:
a magnet assembly located in a cryostat and surrounding a bore so as to define a working region in the bore;
a first sample positioning mechanism insertable in the bore to bring a sample into the working region, the magnet assembly being controllable to generate a magnetic field in the working region having a homogeneity or profile suitable for performing a NMR experiment; and
a second sample positioning mechanism insertable in the bore to bring a sample into the working region, the magnet assembly being controllable to generate a magnetic field in the working region having a homogeneity or profile suitable for performing a different experiment on the sample.

12. Apparatus according to claim 11, wherein the sample positioning mechanisms are insertable into opposite ends of the bore.

13. Apparatus according to claim 11 or claim 12, wherein the bore is at room temperature.

14. Apparatus according to claim 1, 2, 11 or 12, further comprising a system for supplying portions of a sample to each sample positioning mechanism from a common source.

15. Apparatus according to claim 14, wherein the common source comprises a liquid chromatograph.

16. Apparatus according to claim 1, 2, 11 or 12, wherein the second sample positioning mechanism is suitable for use in ion cyclotron resonance mass spectroscopy.
